(19) United States
(12) Patent Application Publication
(10) Pub. No.: US 2022/0358130 A1
(43) Pub. Date: Nov. 10, 2022

(54) IDENTIFY AND EXPLAIN LIFE EVENTS THAT MAY IMPACT OUTCOME PLANS

(71) Applicant: International Business Machines Corporation, Armonk, NY (US)

(72) Inventors: Joao H Bettencourt-Silva, Dublin (IE); Vanessa Lopez Garcia, Dublin (IE); Natalia Mulligan, Dublin (IE); Marco Luca Sbodio, Dublin (IE)

(21) Appl. No.: 17/315,718

(22) Filed: May 10, 2021

(51) Int. Cl. G06F 16/2457; G06F 16/28

(52) U.S. Cl. CPC G06F 16/24575; G06F 16/284

(57) ABSTRACT

A method, system and apparatus for identifying and explaining events, including determining at least one event from a plurality of events, determining at least one outcome defined by an outcome plan, and identifying a relationship between the at least one event and the at least one outcome.

### BACKGROUND

The present invention relates to an embodiment of a method, apparatus, and system for identifying events, and more particularly, but not by way of limitation, relates to a method, apparatus, and system for identifying and explaining life events that may impact outcome plans.

Care professionals need to quickly and accurately find what happened in a case (e.g., since the last appointment or review with an individual). However, the high volume of information, which is often buried in unstructured case notes written by several care professionals working in the same team, makes it easy to overlook changes and events that may impact an outcome plan or individual plan. Such data is difficult to sort through. This is even more critical for vulnerable individuals receiving multiple services. Outcome management has an essential role in assisting an individual to achieve their goal such as remedying a health issue or other outcomes. Outcome management can also be applied in a variety other fields.

Therefore, there is a need to have techniques that can efficiently identify and explain events that may impact outcome plans. There is a need for a technical advancement in machine learning within a computer management system that can rapidly process the large amount of information in question that is difficult to process in a short amount of time.

### SUMMARY

In view of the foregoing and other problems, disadvantages, and drawbacks of the aforementioned background art, an exemplary aspect of the disclosed invention provides a method, apparatus, and system for identifying and explaining life events that may impact outcome plans.

An embodiment includes a method for identifying and explaining events, including determining at least one event from a plurality of events, determining at least one outcome defined by an outcome plan, and identifying a relationship between the at least one event and the at least one outcome.

An embodiment includes a system for identifying and explaining events, including a memory storing computer instructions, and a processor configured to execute the computer instructions to determine at least one event from a plurality of events, determine at least one outcome defined by an outcome plan, and identify a relationship between the at least one event and the at least one outcome.

Another embodiment includes a computer program product comprising a computer readable storage medium having program instructions embodied therewith, the program instructions readable and executable by a computer to cause the computer to perform a method for identifying and explaining events, including determining at least one event from a plurality of events, determining at least one outcome defined by an outcome plan, and identifying a relationship between the at least one event and the at least one outcome.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 illustrates a non-limiting example method to identify and explain events that may impact outcome plans, in accordance with one or more embodiments described herein.

FIG. 2 illustrates non-limiting example of factual relationships, in accordance with one or more embodiments described herein.

FIG. 3 illustrates a non-limiting example timeline, in accordance with one or more embodiments described herein.

FIG. 4 illustrates a non-limiting example timeline, in accordance with one or more embodiments described herein.

FIG. 5 illustrates further detail of a non-limiting example timeline, in accordance with one or more embodiments described herein.

FIG. 6 illustrates a non-limiting example system, in accordance with one or more embodiments described herein.

FIG. 7 illustrates a non-limiting example detail of the input of the system, in accordance with one or more embodiments described herein.

FIG. 8 illustrates a non-limiting example detail of the factual relationships, in accordance with one or more embodiments described herein.

FIG. 9 illustrates a non-limiting example detail of the Life Events Detection Component, in accordance with one or more embodiments described herein.

FIG. 10 illustrates a non-limiting example detail of the Life Events Classification Component, in accordance with one or more embodiments described herein.

FIG. 11 illustrates a non-limiting example detail of the Life Events and Outcomes Relationships Component, in accordance with one or more embodiments described herein.

FIG. 12 illustrates a non-limiting example detail of the Life Events and Outcomes Relationships Component, in accordance with one or more embodiments described herein.

FIG. 13 illustrates a non-limiting example detail of the Life Events and Outcomes Relationships Component, in accordance with one or more embodiments described herein.

FIG. 14 illustrates a non-limiting example detail of the Ranking Component, Alert and Reporting Component and Alert and Reporting Component, in accordance with one or more embodiments described herein.

FIG. 15 illustrates a non-limiting example detail of the User and Feedback Collector Component, in accordance with one or more embodiments described herein.

FIG. 16 illustrates an exemplary hardware/information handling system for incorporating the example embodiment of the present invention therein.

FIG. 17 illustrates a signal-bearing storage medium for storing machine-readable instructions of a program that implements the method according to the example embodiment of the present invention.

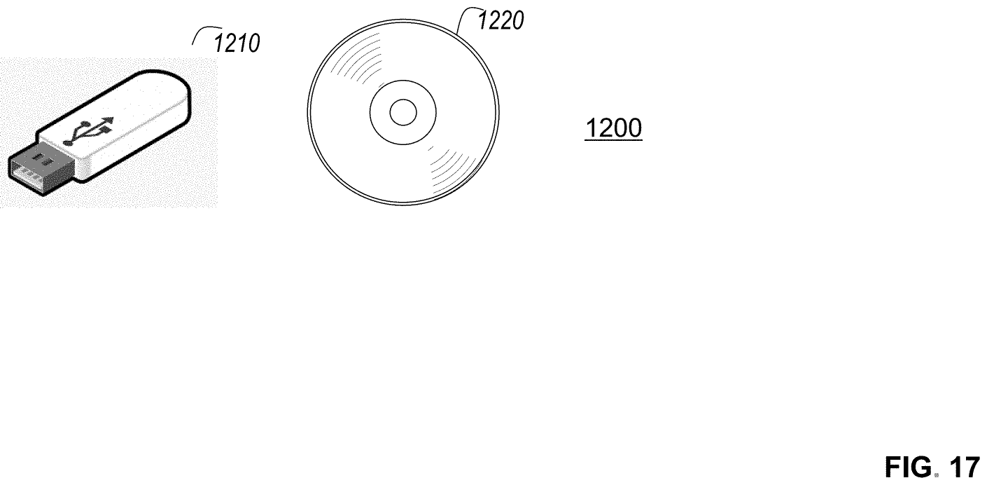

FIG. 18 depicts a cloud computing node according to an example embodiment of the present invention.

FIG. 19 depicts a cloud computing environment according to an example embodiment of the present invention.

FIG. 20 depicts abstraction model layers according to an example embodiment of the present invention.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments will now be described with reference to the drawing figures, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims. Moreover, please note that any of the steps can be performed in different sequences or combined or at the same time. In addition, any of structures and embodiments shown can be modified or combined.

Outcome plans are basically personalized care plans that can provide optimal outcomes for citizens. The citizen engagement process in social care typically starts by identifying needs and strengths, assessing risks and priorities to create an outcome-driven care plan, and it ends with monitoring the plan and evaluating outcomes.

A typical plan contains, for example, goals, notes, actions and associated care activities, progress and results towards an outcome. This data may be either structured or unstructured and is managed by software products such as IBM SPM (Social Program Management), which help care professionals to define and manage outcome plans for individuals. Outcome Management plays a role in assisting a client to achieve their goal. The software can be used to construct an outcome plan to identify and address client needs. These software products typically collect also standard information about an individual, such as age, gender, etc.

A care professional or other type of user can implement an embodiment of the invention. A care professional can define or manage an outcome plan for an individual, where such individual can also be referred to as a “citizen” or “patient”.

An outcome refers to the individual changes in attitudes, behaviours, knowledge, skills, or status resulting from program activities. Example of outcomes can be, for example, smoke cessation, return to work, etc.

Life events can be defined as, for example, discrete experiences that may cause qualitative and quantitative changes and/or readjustments in the life of an individual. Examples of life events can include, for example, marriage, divorce, illness or injury, changing or losing a job, death of family members, birth of child.

Care professionals typically record (some) life events of an individual in her or his care plan. Life events occurring in the household, family or the social context and network of an individual may have positive or adverse impacts in the progress and outcomes of a care plan.

Care professionals need to quickly and accurately find what happened in a case (e.g., since the last appointment or review with an individual). However, the high volume of information (often buried in unstructured case notes written by several care professionals working in the same team) makes it easy to overlook changes and events that may impact an outcome plan. This issue is even more critical for vulnerable individuals receiving multiple services.

An embodiment of the invention helps care professionals using care management software solutions (such as IBM SPM) by identifying life events that may have a possible impact for positive/adverse outcomes in the individual plans.

An embodiment of the invention helps care professionals using care management software solutions (such as IBM SPM) by explaining how and/or why the identified life events are possibly connected to the outcomes in the individual plans. The use by a health care professional is only a non-limiting example. The embodiments of the invention can be applied to any type of technical field and any type of event can be processed as further detailed below.

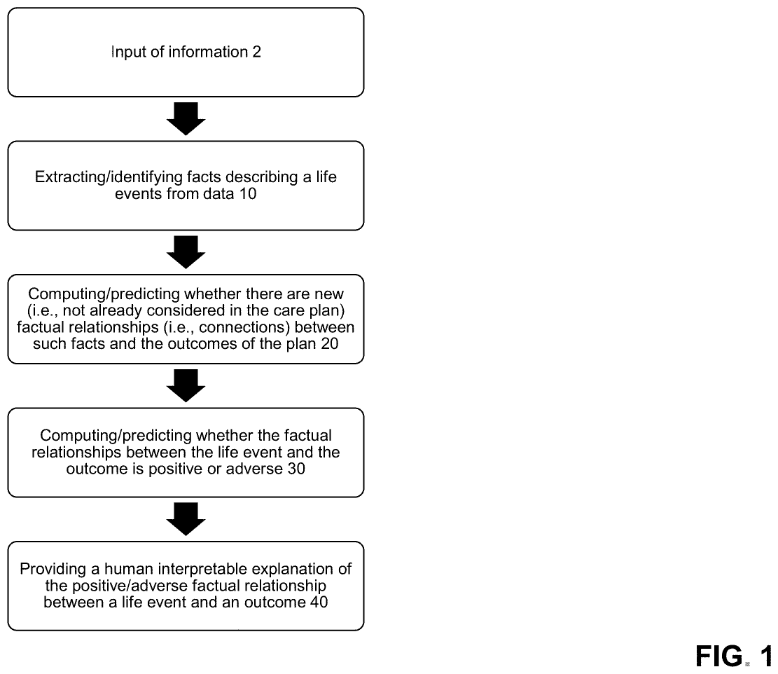

FIG. 1 illustrates a non-limiting example method to identify and explain events that may impact outcome plans, in accordance with one or more embodiments described herein.

Different from existing clinical early warning systems, an embodiment of the invention identifies relevant life events that may have positive and/or adverse effects in an outcome plan while providing suitable explanations.

In an embodiment, a system can perform the following. Input of information can be provided to a system from a user or another machine, or via a network, etc. 2. The user can be, for example, a care professional (e.g., providing information from case notes). The care professional is a non-limiting example. Other type of users can be entering the information, including, for example, corporate users, corporate management, military, individuals at home, etc. Information from case notes is also a non-limiting example. The information can be obtained by a user or machine from a history log, database, etc.

The system performs extracting and/or identifying facts describing a life events from the input of information 2, such as data entered by care professionals (e.g., from case notes) or other input in block 10. The system can performs extracting and/or identifying facts describing other types of events from the input of information 2

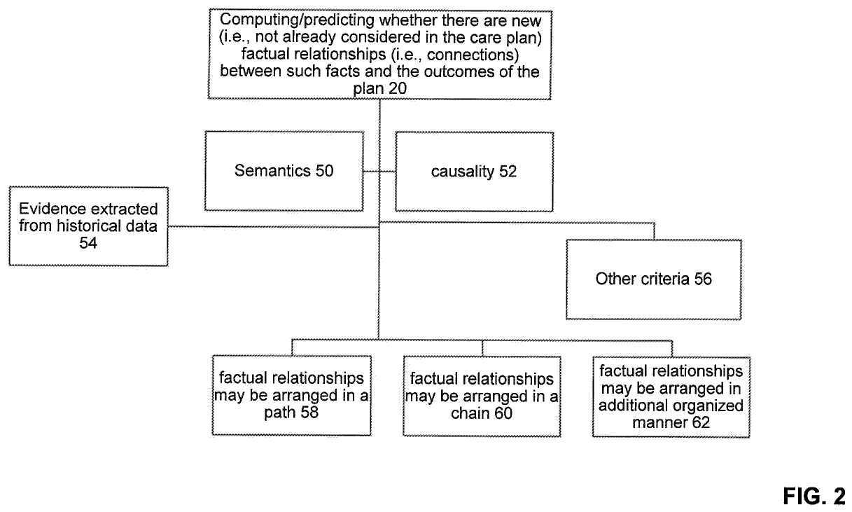

FIG. 2 illustrates non-limiting example of factual relationships, in accordance with one or more embodiments described herein.

The system then executes a process for computing and/or predicting whether there are new (i.e., not already considered in the care plan) factual relationships (i.e., connections) between such facts and the outcomes of the plan 20.

The factual relationships can be based on semantics 50, causality 52, evidence extracted from historical data 54, or various other criteria 56, etc.

The factual relationships may be arranged in a path 58 or chain 60 that connects a life event to an outcome. The factual relationships may also be arranged in other organized methods 62 that connects a life event to an outcome

Referring back to FIG. 1, the system executes a process for computing and/or predicting whether the factual relationships between the life event and the outcome is positive or adverse 30.

In an embodiment, the system provides a human interpretable explanation of the positive and/or adverse factual relationship between a life event and an outcome 40.

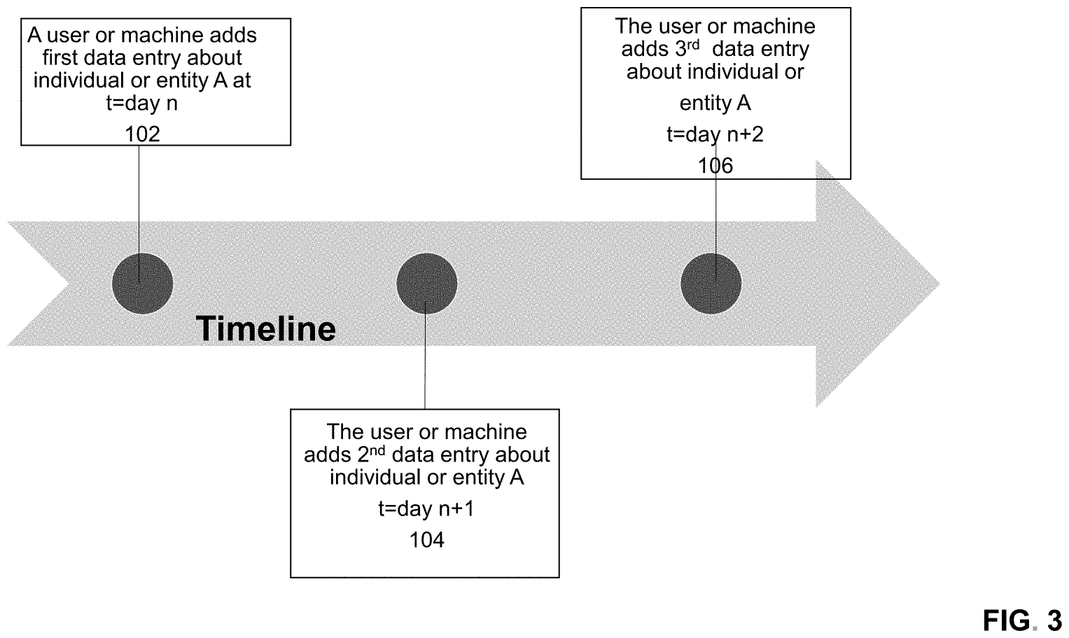

FIG. 3 illustrates a non-limiting example timeline, in accordance with one or more embodiments described herein.

In a non-limiting example, a user or machine adds first data entry about individual or entity A 1at t=day n 102, where n is an integer. The individual can be for example, a patient, an employee, a random individual, etc. The entity can be, for example, a company, another machine, a group of individuals, etc. Instead of a patient, the target can also be an object.

The user or machine then adds a second data entry about individual or entity A at t=day n+1 104. The user or machine then adds a third data entry about individual or entity A at t=day n+2 106.

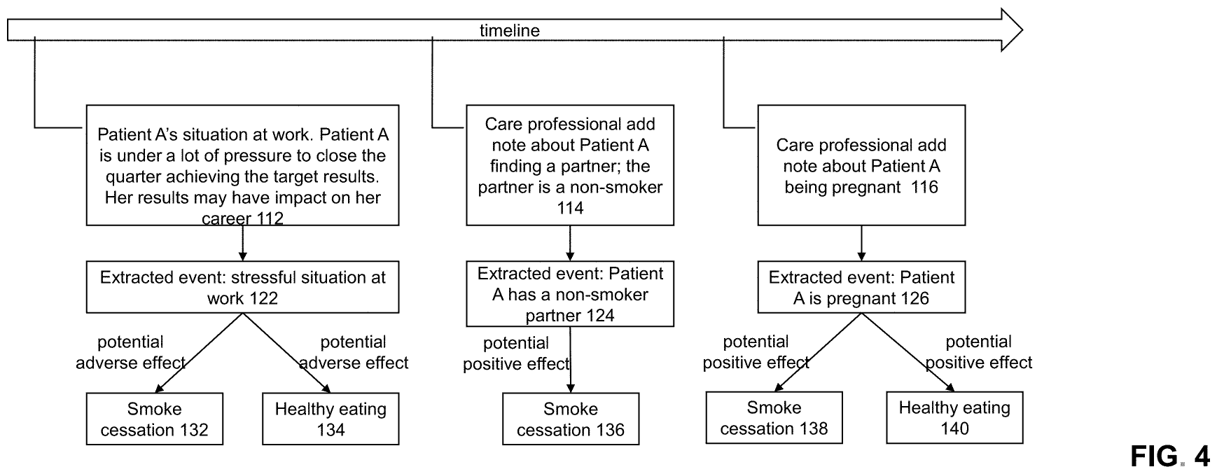

FIG. 4 illustrates a non-limiting example timeline, in accordance with one or more embodiments described herein.

In a non-liming example, there is an outcome plan for an individual “patient A”. The outcome plan or output program can also be for a “target data object” if applied in a different example. The plan can be also for a corporate entity, object, or a group, etc. The outcome plan for patient A is to provide a (1) a cessation to smoking, and (2) healthy eating.

In the beginning (e.g., time=day 1), the care professional adds note about patient A's situation at work 112 and this information is provided as an input into the system. Patient A is under a lot of pressure to close the quarter achieving the target results. Her results may have impact on her career.

The system, then extracts or identifies the event as a stressful situation at work 122. The system then, based on the inputted information and extracted event, determines a potential adverse effect of failure of smoke cessation 132, and also the potential adverse effect of failure of healthy eating 134.

In the next time period (e.g., time=day 2), the Care professional adds or inputs into the system a note about patient A finding a partner; the partner is a non-smoker 114.

The system then extracts or identifies the event as patient A has a non-smoker partner 124. The system then determines that the potential positive effect is smoke cessation 136. No determination as to healthy eating is made.

Then, in the next time period (e.g., time=day 2), care professional adds note about patient A being pregnant, which is entered into the system at 116. The system then extracts from the input that patient A is pregnant at 126. The system then determines the potential positive effect of Smoke cessation 138 and also the potential positive effect of healthy eating 140.

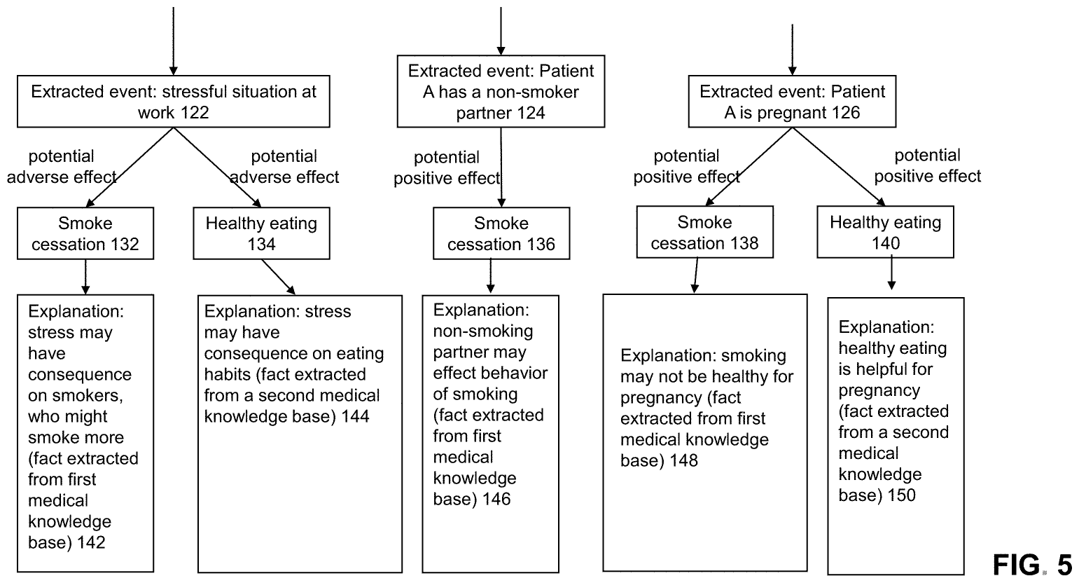

FIG. 5 illustrates further detail of a non-limiting example timeline, in accordance with one or more embodiments described herein. The system also outputs explanations of the factual relationships as shown in the following example. For example, explanation that “stress may have consequence on smokers, who might smoke more” is outputted by the system at 142 for output smoking cessation 132. The system obtains this fact from data extracted from a first medical knowledge base. The Explanation of “stress may have consequence on eating habits” is a fact extracted from a second medical knowledge base at 144 for output healthy eating at 134.

An explanation of “non-smoking partner may effect behavior of smoking” is a fact extracted from first medical knowledge base 146 for smoking cessation output 136. An explanation of “smoking may not be healthy for pregnancy” is a fact extracted from first medical knowledge base 148 for smoking cessation output at 138. An explanation of “healthy eating is helpful for pregnancy” is a fact extracted from a second medical knowledge base 150 for the healthy eating output 150.

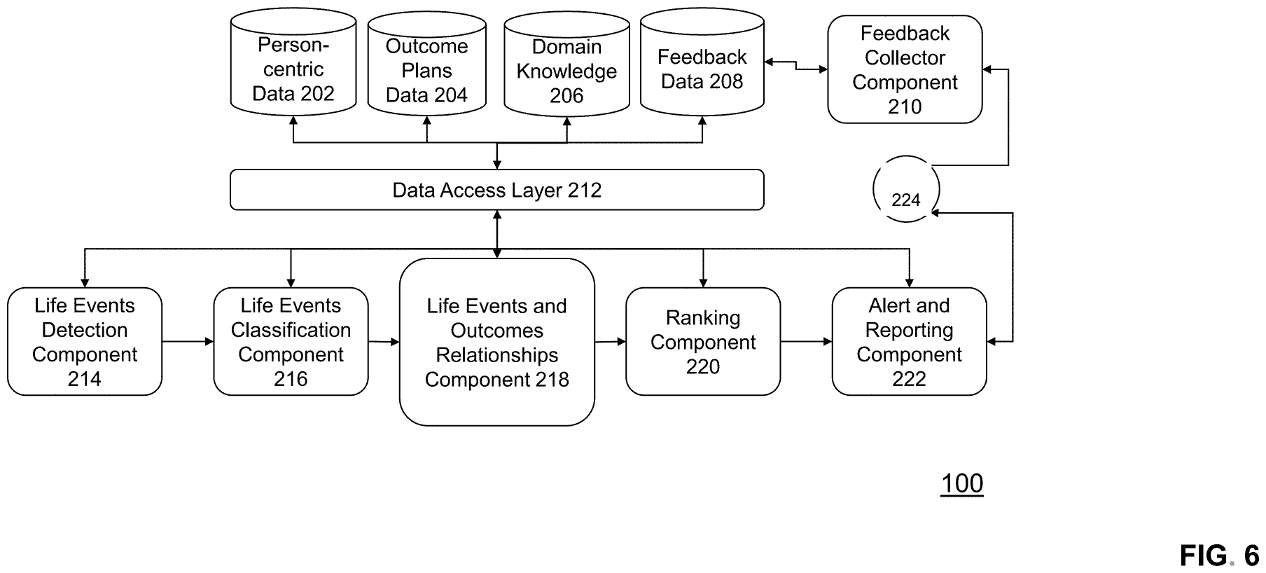

FIG. 6 illustrates a non-limiting example system, in accordance with one or more embodiments described herein.

The system 100 can include the following modules linked by a data access layer 212. Person-centric Data module 202, outcome plans data database 204, domain knowledge database 206 and feedback data database link through the data access layer 212. The feedback data database communicates with the feedback collector component 210. A user (e.g., care professional) or machine 224 can input data into the feedback collector component 210.

The Life Events Detection Component 214, Life Events Classification Component 216, Life Events and Outcomes Relationships Component 218, Ranking Component 220, and Alert and Reporting Component 222 are linked with each other, and linked with the data access layer 212. The Alert and Reporting Component 222 can provide an output to the user and/or machine 224.

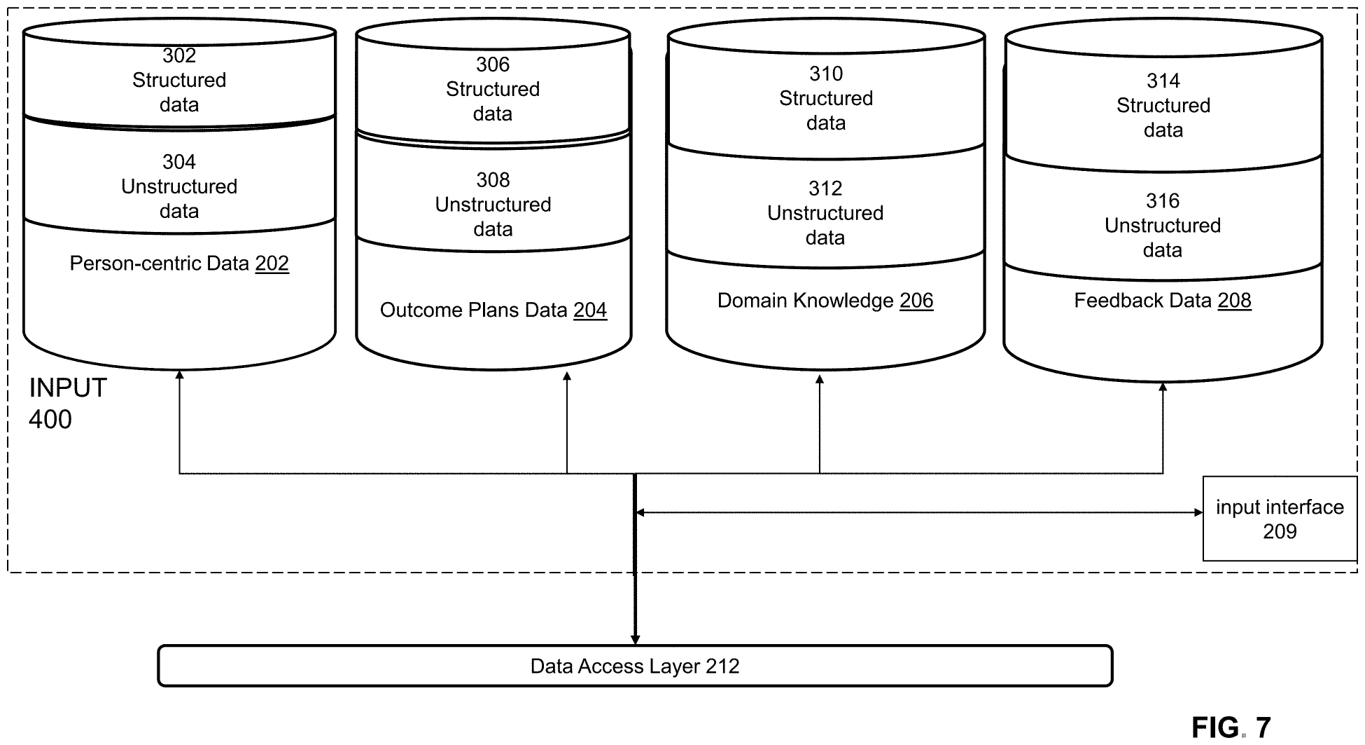

FIG. 7 illustrates a non-limiting example detail of the input of the system, in accordance with one or more embodiments described herein.

The input 400 of the system can include the Person Centric Data module 202. The personal centric data module can include structured data 302 (e.g., electronic health records, etc.) and unstructured data 304 (e.g., case notes, text) data. Generally, the structured data 302 is highly organized and formatted so that it's easily searchable in relational databases. On the other hand, the unstructured data 304 has generally no predefined format or organization, making it much more difficult to collect, process, and analyze. The unstructured data, for example, includes all the information a care professional usually collects and review to create a care plan for the individual.

Examples of the unstructured data 304 includes health history (electronic health records), social and behavioral situations, other risk variables or social needs that may influence care (e.g., if the person is homeless), personal details (age, gender, etc.), demographics, family situation and social connections, communities or places where the individual belongs, etc. Individual information from social media (if available) could also be leveraged. Additionally, activities and context of daily living (if available) could also be leveraged. The unstructured data 304 examples can also be entered as structured data 302 if there is a predefined format.

The input 400 also includes Outcome Plans Data module 204 can include, for example, such data that include goals, interventions, care activities and plans, progress, strengths and needs and/or risk factors, notes, etc. The outcome plans data 204 can generally include all the information for the outcome plan. Outcome Plans Data module 204 can be, for example, a database, or a table. The Outcome Plans Data module 204 can also include data in structured 306 and unstructured 308 format.

The input 400 also includes Domain Knowledge database 206 can include data sources (structured data 310 and unstructured data 312) useful to find semantic connections and/or train evidence-based AI (artificial intelligence) models to find relevant life events, their polarity and connections. For example, deprivation indexes, literature or databases on social determinants, positive/adverse life events classifications, social services, encyclopaedia of life events, models and historical data for demographics, household and family/social connections, etc.

The input 400 includes Feedback Data module 208 can include data collected from the team of care professionals who have reviewed previous predictions of our system. The feedback data module 208 may include a quantitative score, for example in the range [0,1], and other information to express the accuracy/usefulness of the predictions. Feedback Data module 208 can also include data in structured 306 and unstructured 308 format.

The input 400 can also include Data Access Layer 212 component works as a data provider for all other components. It essentially provides access to various data sources, including the Person-centric data 202, Outcome plans data 204, Domain Knowledge 206, Feedback Data 208.

Other data sources also be added as these are merely examples. Moreover, the data can be entered through other channels such as an input interface 209 which can receive input from internal or external individual or entity, or machine.

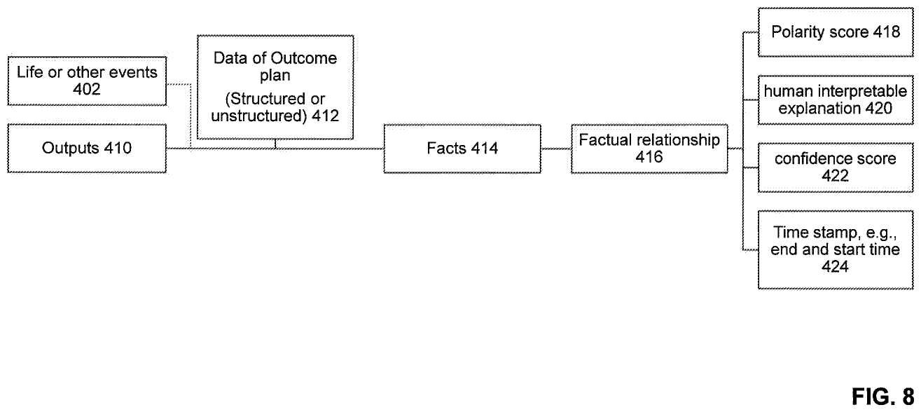

FIG. 8 illustrates a non-limiting example detail of the factual relationships, in accordance with one or more embodiments described herein.

The Outputs can be shown as follows. Factual relationships 416 between life events 402 and the outcomes 404 that are defined in an individual outcome plan, where each factual relationship consists of one or more facts (possibly arranged into a temporal sequence) 414 that potentially connect a life event (or other event) 402 to an outcome 410. A fact 414 is an information item extracted from data about the individual, group, or entity 412. Such data (data of outcome plan 412) can be available in existing care-plan management software solutions, and it can be either structured or unstructured (e.g., text). A polarity score 418, which indicates if the factual relationship between the life event 402 and the outcome 410 is positive or adverse can be included. A human interpretable explanation 420 of the factual relationship can also be included. Confidence scores 422 can also be added.

The factual relationship 416 may include a timestamp t_s 424 indicating when the relationship 416 starts to be valid in time, and a timestamp t_e 424 indicating when the relationship ceases to be valid in time. The system may inform or alert care professionals that monitor and review the execution of the care plan and/or recommend the steps to amend the plan if needed.

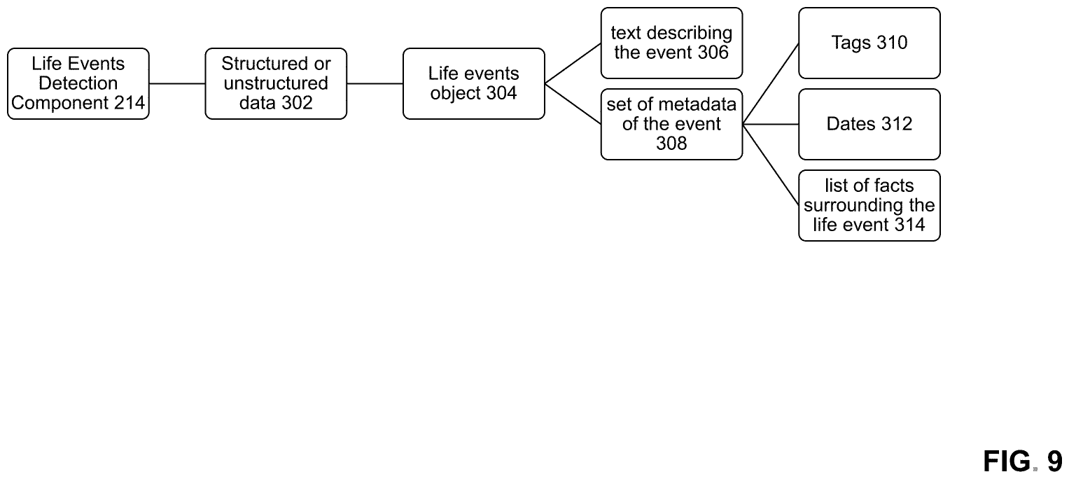

FIG. 9 illustrates a non-limiting example detail of the Life Events Detection Component, in accordance with one or more embodiments described herein.

Referring to FIGS. 6 and 9, there is Life Events Detection Component 214. The Life events detection component 214 detects life events. The Life events detection component 214 may extract life events from structured data (for example electronic health records), or from unstructured data (for example care manager notes, and similar documents) 302. The output of the component is a “life event object” 304 or other type of event object, including text describing the event 306. The life event object 304 can also include a set of metadata of the event 308, including tags 310, dates 312, and list of facts surrounding the life event 314, etc. A fact may be a fragment of text, or some set of structured data coming from EHRs (electronic health records) or sensors readings. The component may use a combination of techniques and time-series-analysis techniques.

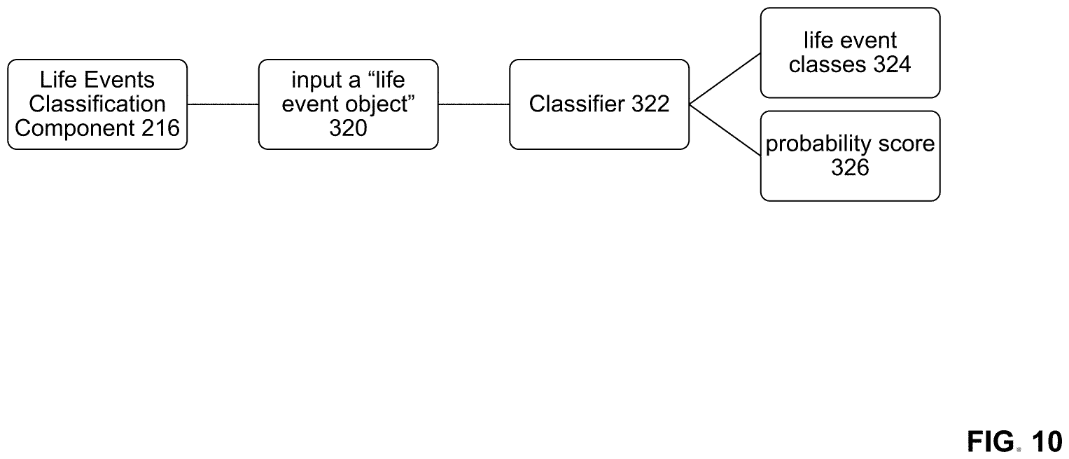

FIG. 10 illustrates a non-limiting example detail of the Life Events Classification Component, in accordance with one or more embodiments described herein.

The Life Events Classification Component 216 classifies life events into a finite number of classes. The component is able to identify events of the classes “positive events” (which are event having a potentially positive effect on an individual's life or that of a group.) and “adverse events” (which are event having a potentially adverse effect on an individual's life or that of a group) 324.

For example, Life Events Classification Component 216 takes as input a “life event object” 320 and produces as output a “life event class” 324, which is a binary value, where “1” indicates that the life event is adverse, and “0” indicates that the life event is positive.

The Life Events Classification Component 216 may also produce a probability score 326 that indicates the confidence of the classification: for example, <life-event-class=1, probability=0.82>, indicates that the life event is adverse with a probability of 82%.

In an embodiment the Life Events Classification Component 216 uses a classifier 322, trained on historical data. Such classifier 322 may use any technique to classify text. For example, the component 216 may consist of a text classifier using the pre-trained language model.

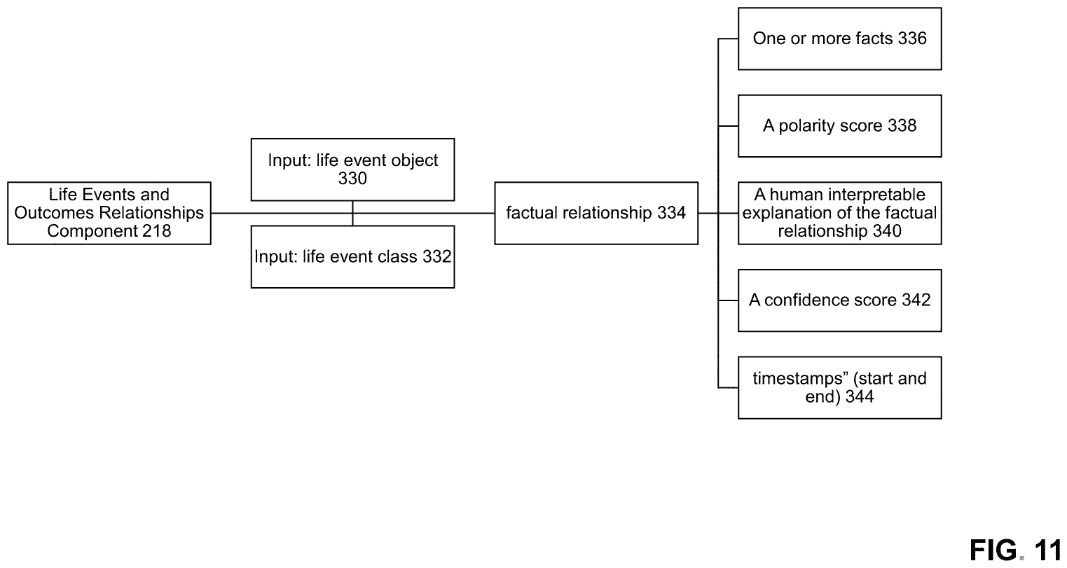

FIG. 11 illustrates a non-limiting example detail of the Life Events and Outcomes Relationships Component, in accordance with one or more embodiments described herein.

In an embodiment, the Life Events and Outcomes Relationships Component 218 takes as input a “life event object”330, and its corresponding “life event class” 332, and produces as output “factual relationships” 334 between facts surrounding the positive or adverse life event, and Outcomes defined in an outcome plan.

A “factual relationship” includes one or more facts (possibly arranged into a temporal sequence) that potentially connect a life event to an outcome 336. A fact is an information item extracted from data about the individual (or group, or entity). Such data can be available in a care-plan management software, and it can be either structured or unstructured (text). In an embodiment, the Life events and outcomes relationship component 218 can also output a polarity score 338, which indicates if the factual relationship between the life event and the outcome is positive or adverse.

In an embodiment, the Life events and outcomes relationship component 218 can also output a human interpretable explanation of the factual relationship 340. In an embodiment, the Life events and outcomes relationship component 218 can also output a confidence score 342. The “factual relationship” 334 may also include two “timestamps” (start and end) 334. The two “timestamps” 344 indicates when the relationship starts to be valid (start timestamp), and when the relationship ceases to be valid (end timestamp). The end timestamp 344 can be optional. The relationships 334 computed by this Life Events and Outcomes Relationships Component 218 are particularly helpful for life events that have been classified as adverse. However, the Life Events and Outcomes Relationships Component 218 also produces helpful factual relationships 334 also for non-adverse life events.

In an embodiment, a “factual relationship” includes, for example, a “motivation”, and a “score”: The “motivation” is an explanation of why a set of facts, F, related to the life event E is connected to an outcome O in an outcome plan. The motivation may, for example, consist of fragment of text, or a set of tags. The “score” can be, for example, a number (e.g., normalized between 0 and 1) that represents the strength of the connection between F and O. The “factual relationship” may also include two “timestamps” (start and end). The two “timestamps” indicates when the relationship starts to be valid (start timestamp), and when the relationship ceases to be valid (end timestamp). The end timestamp can be optional.

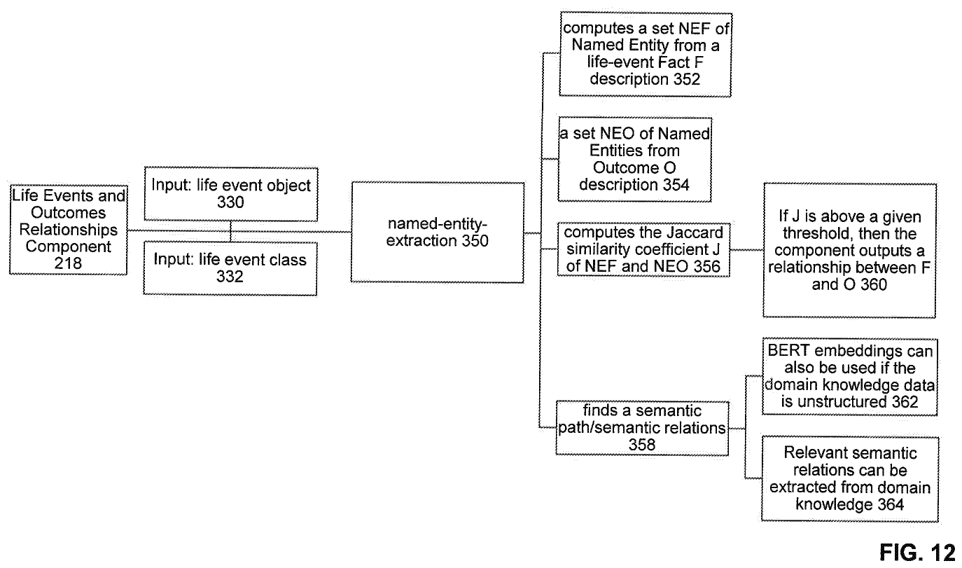

FIG. 12 illustrates a non-limiting example detail of the Life Events and Outcomes Relationships Component, in accordance with one or more embodiments described herein.

In an embodiment, the Life Events and Outcomes Relationships Component 218 works as follows. The Life Events and Outcomes Relationships Component 218 uses named-entity-extraction 350. The Life Events and Outcomes Relationships Component 218 computes a set NEF of Named Entity from a life-event Fact “F” description 352, and a set NEO of Named Entities from Outcome “O” description 354.

The Life Events and Outcomes Relationships Component 218 computes, for example, the Jaccard similarity coefficient “J” of NEF 352 and NEO 354 at 356. If “J” is above a given threshold, then the component outputs a relationship between F and O, where the motivation is given by the intersection of NEF and NEO, and the score is equal to J 360.

The Life Events and Outcomes Relationships Component 218 finds a semantic path and/or semantic relations connecting the named entities surrounding the life event facts, and entities in the outcomes progress and plans 358. Relevant semantic relations can be extracted from domain knowledge (e.g., a causality or side effect relation) 364. BERT (Bidirectional Encoder Representations from Transformers) embeddings can also be used if the domain knowledge data is unstructured 362.

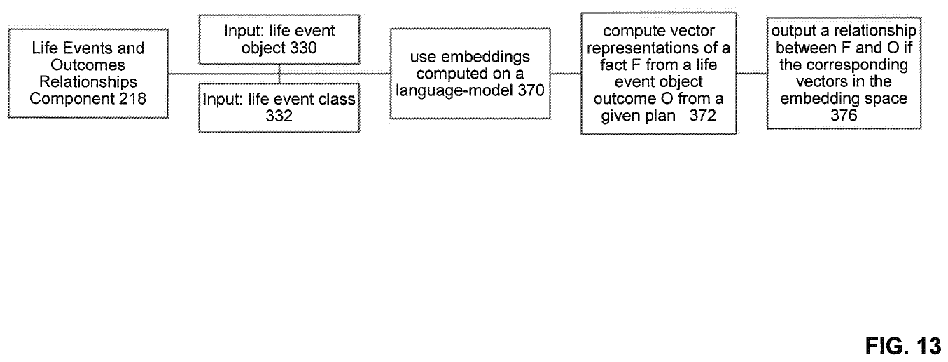

FIG. 13 illustrates a non-limiting example detail of the Life Events and Outcomes Relationships Component, in accordance with one or more embodiments described herein.

In another alternative embodiment, the Life Events and Outcomes Relationships Component may use embeddings computed on a language-model such as BERT 370 to compute vector representations of a fact F from a life event object and an outcome O from a given plan 372. The Life Events and Outcomes Relationships Component 218 may output a relationship between F and O if the corresponding vectors in the embedding space are close enough (threshold-based) given a distance metric 376.

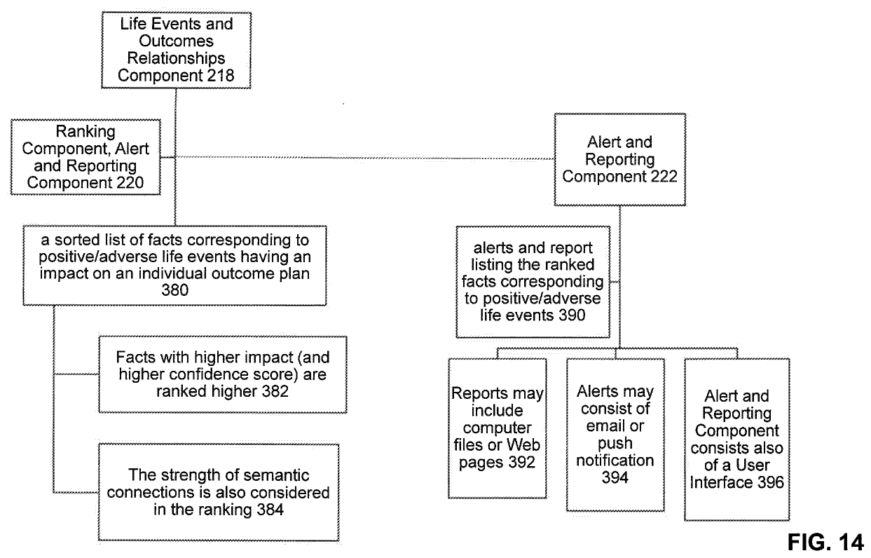

FIG. 14 illustrates a non-limiting example detail of the Ranking Component, Alert and Reporting Component and Alert and Reporting Component, in accordance with one or more embodiments described herein.

The Ranking Component, Alert and Reporting Component 220 is a ranking system, which uses information computed by the Life Events and Outcomes Relationships Component 218 to compute a sorted list of facts corresponding to positive and/or adverse life events having an impact on an individual outcome plan 380.

The Facts with higher impact (and higher confidence score) are ranked higher, that is they appear at the beginning of the list 382. The strength of semantic connections is also considered in the ranking (e.g. direct link vs. indirect links, support/weight from the literature, etc.) 384.

The Alert and Reporting Component 222 generates alerts and report listing the ranked facts (from Ranking Component, Alert and Reporting Component 220) from the corresponding to positive and/or adverse life events and having an impact on a person's outcome plan (together with motivations and scores) 390. The motivation may consist of fragment of text, or a set of tags. The “score” is a number (usually normalized between 0 and 1) that represents the strength of the connection between F (fact) and O (outcome).

The Reports may consist of computer files, such as PDF (portable document format) documents or Web pages, or other formatted computer files 392. The alerts may consist of email or push notification 394 or other type of alert. The Alert and Reporting Component 222 consists also of a User Interface 396 that shows the alert and reports to a User. The user interface 396 can be a display with an input interface, or a mobile device, etc. The user interface 396 can also be a Web-based User Interface.

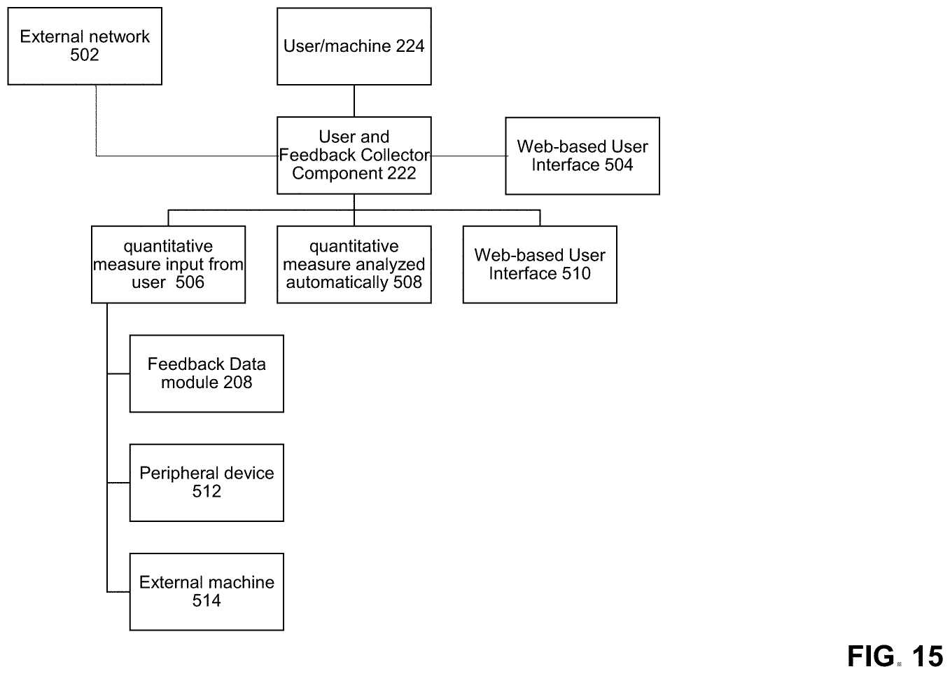

FIG. 15 illustrates a non-limiting example detail of the User and Feedback Collector Component, in accordance with one or more embodiments described herein.

The User and Feedback Collector Component 222 collects the following information.

The User 224 (which can also be a machine) of the system can be a Subject Matter Expert (SME), such as a care professional, who manages care plans and outcome plans involving a person.

The Feedback Collector Component 224 allows the user 224 to express feedback about the output of the system. In an embodiment, the feedback consists of a integer value (from 1 to 5) which represents a quantitative measure 506 of how much the user agrees with the output of the system, that is how much the user find the output of the system useful/important/correct (5 being very high, and 1 being very low).

In one embodiment, the Feedback Collector Component 222 consists of Web-based User Interface 504. The system may inform or alert care professionals that monitors and review the execution of the care plan and or recommend the steps to amend the plan if needed via the interface 504. Such feedback is potentially used by the system to improve predictive AI (Artificial Intelligence) models and the accuracy of future computations.

Differently from health events, life events are complex and multidisciplinary in nature and therefore difficult to detect. Assessing and checking every time there is a change in circumstances, for an individual and household, whether there is an impact on the risks, vulnerability and/or eligibility to care services, and why, is difficult point due to the vast amount of documentations and notes written by different care professionals.

Care professionals need to quickly and accurately find what happened in a case (e.g., since the last appointment or review with an individual). However, the high volume of information (often buried in unstructured case notes written by several care professionals working in the same team) makes it easy to overlook changes and events that may impact an outcome plan. This is even more critical for vulnerable individuals receiving multiple services. Therefore, integration into a computer system is necessary since the information is of a high volume, time critical, and analysis is needed of the information.

Therefore, care professionals with system of an embodiment can identifying life events that may have a possible impact for positive/adverse outcomes in the individual plans. The system of an embodiment can also explain how, and/or why the identified life events are possibly connected to the outcomes in the individual plans. In an embodiment, the system can be part of an early warning system for care professionals in the social and welfare domain.

In an embodiment, the system can build on top of existing social care systems (such as IBM SPM), however its applicability can be broader than the social care domain. The events can be any type of event. For example, the online advertising industry can implement the system of an embodiment. In such a domain, the outcome of an online advertisement action is to influence the individual buying decision, possibly in a positive way.

In an embodiment, the system can help automated online advertisement by providing an additional signal to the advertisement engine. Such signal can consist of the factual relationships between life events/actions/preferences of an individual (typically available in the individual social media streams), and the individual propension to click on the advertisement or buy the product. The polarity and confidence score provided by our invention may be very useful in this domain.

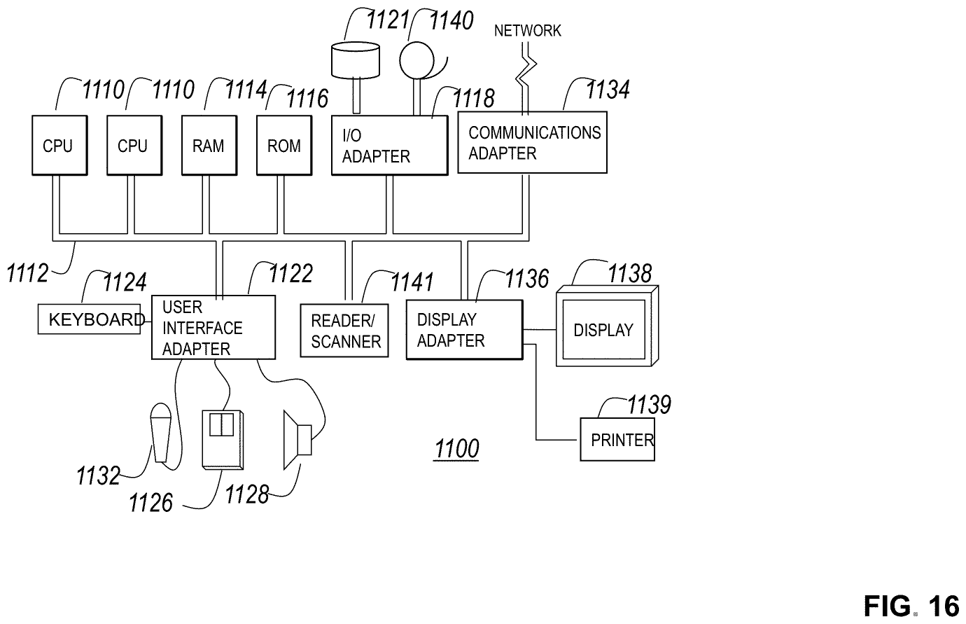

FIG. 16 illustrates another hardware configuration of the system, where there is an information handling/computer system 1100 in accordance with the present invention and which preferably has at least one processor or central processing unit (CPU) 1110 that can implement the techniques of the invention that can produce as output “factual relationships” between facts surrounding the adverse life event, and outcomes defined in an outcome plan, such that it can process and analyze in a rapid manner the vast amount of data.

The CPUs 1110 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 1122 (for connecting a keyboard 1124, mouse 1126, speaker 1128, microphone 1132, and/or other user interface device to the bus 1112), a communication adapter 1134 for connecting an information handling system to a data processing network, the Internet, an Intranet, a personal area network (PAN), etc., and a display adapter 1136 for connecting the bus 1112 to a display device 1138 and/or printer 1139 (e.g., a digital printer or the like).

Therefore, for example, in an embodiment as shown above, a component of a computer system, such as the CPU 1110 can take as input a “life event object”, and its corresponding “life event class”, and produces as output “factual relationships” between facts surrounding the adverse life event, and outcomes defined in an outcome plan, such that it can process and analyze in a rapid manner the vast amount of data. The CPU 1110 can analyze the “factual relationship”, which includes, for example, a “motivation”, and a “score”. The “motivation” may consist of fragment of text, or a set of tags that is processed by the CPU 1110. The “score” can be a number (normalized between 0 and 1) that represents the strength of the connection between F and O for processing by the CPU 1110. The “factual relationship” may also include two “timestamps” (start and end) that is analyzed by the CPU 1110. The output from the analysis and machine learning by the CPU 1110 can be displayed on display device 1138 or the information can be sent externally through a network.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing storage media tangibly embodying a program of machine-readable instructions executable by a digital data processor incorporating the CPU 1110 and hardware above, to perform the method of the invention.

This signal-bearing storage media may include, for example, a RAM contained within the CPU 1110, as represented by the fast-access storage for example.

Alternatively, the instructions may be contained in another signal-bearing storage media 1200, such as a flash memory 1210 or optical storage diskette 1220 (FIG. 27), directly or indirectly accessible by the CPU 1110.

Whether contained in the flash memory 1210, the optical disk 1220, the computer/CPU 1110, or elsewhere, the instructions may be stored on a variety of machine-readable data storage media.

Therefore, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

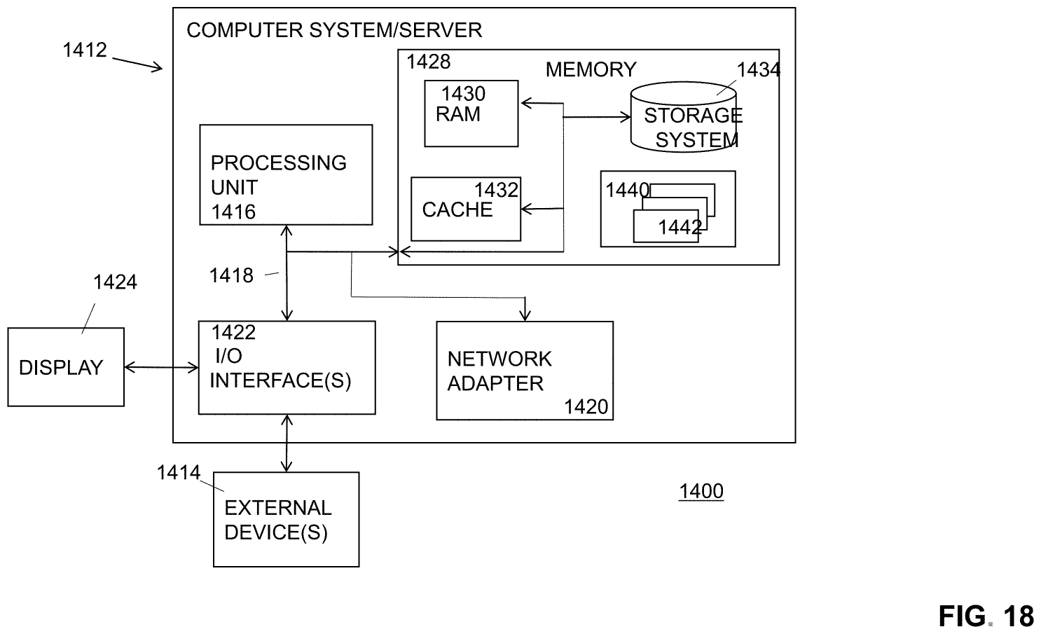

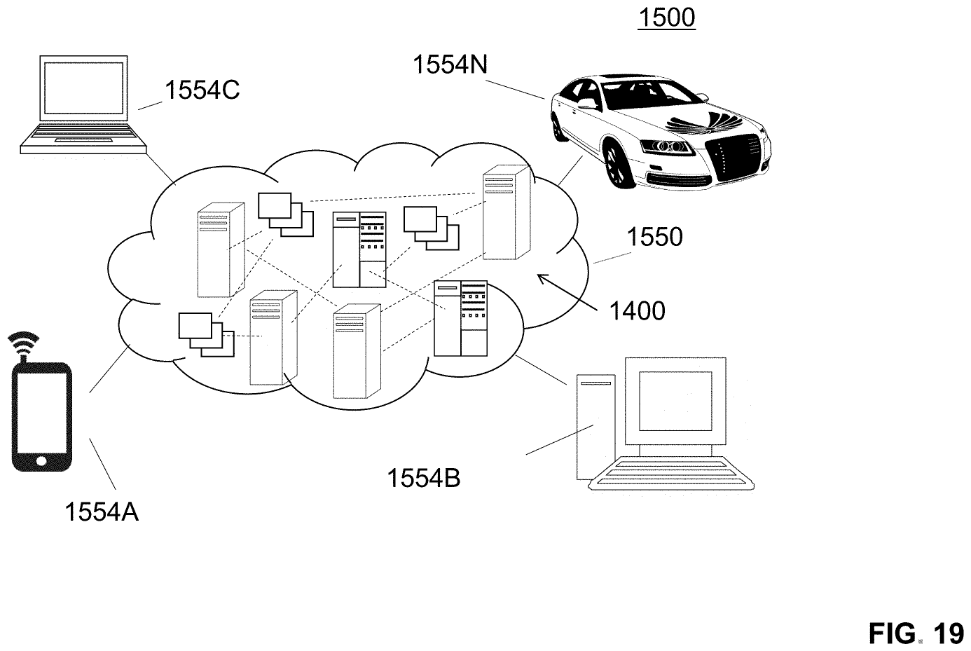

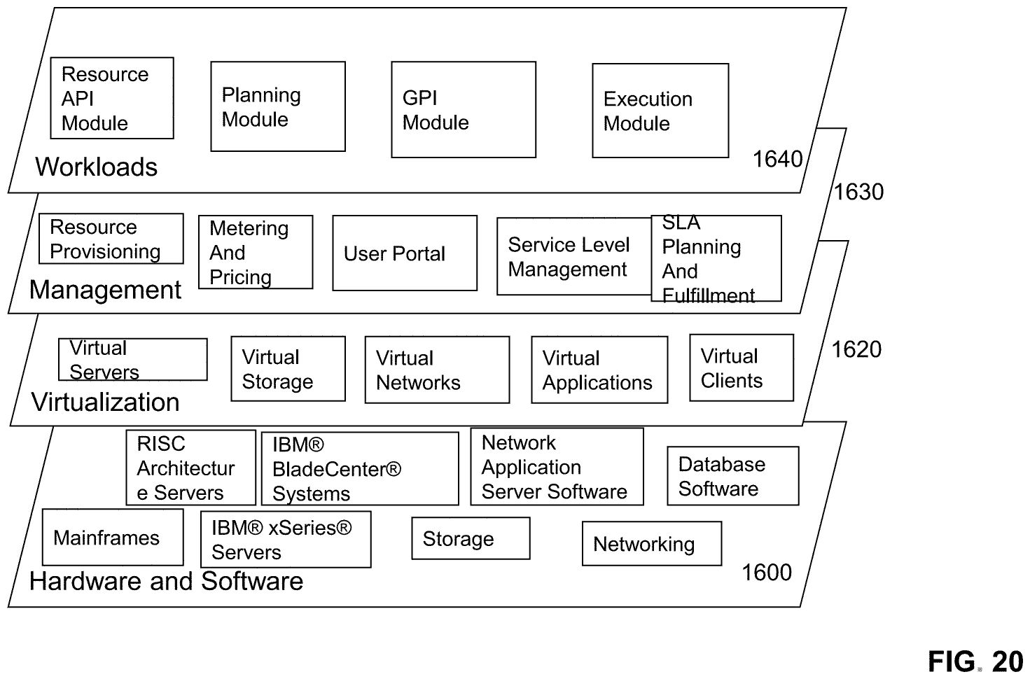

Referring now to FIG. 18, a schematic 1400 of an example of a cloud computing node is shown. Cloud computing node 1400 is only one example of a suitable cloud computing node and is not intended to suggest any limitation as to the scope of use or functionality of embodiments of the invention described herein. Regardless, cloud computing node 1400 is capable of being implemented and/or performing any of the functionality set forth hereinabove. System 100 of FIG. 6 can be implemented in a cloud infrastructure such as FIG. 18 (and also FIGS. 19 and 20) such as the cloud computing node 1400.

Therefore, for example, in an embodiment as shown above, a component of the cloud computing node 1400 can take as input a “life event object”, and its corresponding “life event class”, and produces as output “factual relationships” between facts surrounding the adverse life event, and outcomes defined in an outcome plan, such that it can process and analyze in a rapid manner the vast amount of data. The output from the analysis and machine learning by the cloud computing node 1400 can be, for example, displayed on a peripheral device or can be sent to another device through the network.

In cloud computing node 1400 there is a computer system/server 1412, which is operational with numerous other general purpose or special purpose computing system environments or configurations. Examples of well-known computing systems, environments, and/or configurations that may be suitable for use with computer system/server 1412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1412 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1412 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 18, computer system/server 1412 in cloud computing node 1400 is shown in the form of a general-purpose computing device. The components of computer system/server 1412 may include, but are not limited to, one or more processors or processing units 1416, a system memory 1428, and a bus 1418 that couples various system components including system memory 1428 to processor 1416.

Bus 1418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1412 typically includes a variety of computer system readable media. Such media may be any available media that is accessible by computer system/server 1412, and it includes both volatile and non-volatile media, removable and non-removable media.

System memory 1428 can include computer system readable media in the form of volatile memory, such as random-access memory (RAM) 1430 and/or cache memory 1432. Computer system/server 1412 may further include other removable/non-removable, volatile/non-volatile computer system storage media. By way of example only, storage system 1434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1418 by one or more data media interfaces. As will be further depicted and described below, memory 1428 may include at least one program product having a set (e.g., at least one) of program modules that are configured to carry out the functions of embodiments of the invention.

Program/utility 1440, having a set (at least one) of program modules 1442, may be stored in memory 1428 by way of example, and not limitation, as well as an operating system, one or more application programs, other program modules, and program data. Each of the operating system, one or more application programs, other program modules, and program data or some combination thereof, may include an implementation of a networking environment. Program modules 1442 generally carry out the functions and/or methodologies of embodiments of the invention as described herein.

Computer system/server 1412 may also communicate with one or more external devices 1414 such as a keyboard, a pointing device, a display 1424, etc.; one or more devices that enable a user to interact with computer system/server 1412; and/or any devices (e.g., network card, modem, etc.) that enable computer system/server 1412 to communicate with one or more other computing devices. Such communication can occur via Input/Output (I/O) interfaces 1422. Still yet, computer system/server 1412 can communicate with one or more networks such as a local area network (LAN), a general wide area network (WAN), and/or a public network (e.g., the Internet) via network adapter 1420. As depicted, network adapter 1420 communicates with the other components of computer system/server 1412 via bus 1418. It should be understood that although not shown, other hardware and/or software components could be used in conjunction with computer system/server 1412. Examples, include, but are not limited to: microcode, device drivers, redundant processing units, external disk drive arrays, RAID systems, tape drives, and data archival storage systems, etc.

Referring now to FIG. 19, illustrative cloud computing environment 1550 is depicted. As shown, cloud computing environment 1550 includes one or more cloud computing nodes 1400 with which local computing devices used by cloud consumers, such as, for example, personal digital assistant (PDA) or cellular telephone 1554A, desktop computer 1554B, laptop computer 1554C, and/or automobile computer system 1554N may communicate. Nodes 1400 may communicate with one another. They may be grouped (not shown) physically or virtually, in one or more networks, such as Private, Community, Public, or Hybrid clouds as described hereinabove, or a combination thereof. This allows cloud computing environment 1550 to offer infrastructure, platforms and/or software as services for which a cloud consumer does not need to maintain resources on a local computing device. It is understood that the types of computing devices 1554A-N shown in FIG. 18 are intended to be illustrative only and that computing nodes 1400 and cloud computing environment 1550 can communicate with any type of computerized device over any type of network and/or network addressable connection (e.g., using a web browser).

Referring now to FIG. 20, a set of functional abstraction layers provided by cloud computing environment 1550 (FIG. 19) is shown. It should be understood in advance that the components, layers, and functions shown in FIG. 20 are intended to be illustrative only and embodiments of the invention are not limited thereto. As depicted, the following layers and corresponding functions are provided:

Hardware and software layer 1600 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1620 provides an abstraction layer from which the following examples of virtual entities may be provided: virtual servers; virtual storage; virtual networks, including virtual private networks; virtual applications and operating systems; and virtual clients.

In one example, management layer 1630 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1640 provides examples of functionality for which the cloud computing environment may be utilized. Examples of workloads and functions which may be provided from this layer include such functions as mapping and navigation; software development and lifecycle management; virtual classroom education delivery; data analytics processing; transaction processing.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A method of identifying and explaining events, the method comprising:
determining at least one event from a plurality of events;
determining at least one outcome defined by an outcome plan; and
identifying a relationship between the at least one event and the at least one outcome.

2. The method according to claim 1, wherein at least a first data of information being arranged into a temporal space connects the at least one event to the at least one outcome, and
wherein the relationship includes a motivation and a score, the motivation comprises an output of an analysis of a link between the first data of information related to the event and the at least one outcome in the outcome plan, the motivation includes fragments of text, or a set of tags, the score includes a normalized set of numbers representing a strength of connection between the first data of information and the outcome.

3. The method according to claim 2, wherein the first data of information comprises an information item extracted from data about an individual user, the first data of information including structured and unstructured data.

4. The method according to claim 1, further comprising generating a polarity score which indicates whether the relationship between the event and the outcome is positive or adverse.

5. The method according to claim 1, further comprising generating a confidence score for the identifying the relationship between the at least one event and the at least one outcome with additional data.

6. The method according to claim 1, wherein the relationship is based on at least one of semantics, causality, and evidence extracted from historical data.

7. The method of claim 1, wherein the relationship includes a factual relationship that includes a timestamp indicating when the relationship starts to be valid in time, and a timestamp indicating when the relationship ceases to be valid in time.

8. The method of claim 1, further comprising:
identifying a plurality of the relationships; and
ranking the relationships based on their corresponding polarity or confidence score.

9. The method of claim 8, wherein the relationships are reported to a user or computing device, and
further comprising alerting a user or a machine to amend the outcome plan.

10. The method of claim 1, wherein the user provides feedback on the relationship for machine learning.

11. The method according to claim 1, being implemented in a cloud environment.

12. A system for identifying and explaining events, comprising:
a memory storing computer instructions; and
a processor configured to execute the computer instructions to:
determine at least one event from a plurality of events;
determine at least one outcome defined by an outcome plan; and
identify a relationship between the at least one event and the at least one outcome.

13. The system according to claim 12, wherein at least a first data of information being arranged into a temporal space connects the at least one event to the at least one outcome, and
wherein the first data of information comprises an information item extracted from data about an individual user, and
wherein the relationship includes a motivation and a score, the motivation comprises an output of an analysis of a link between the first data of information related to the event and the at least one outcome in the outcome plan, the motivation includes fragments of text, or a set of tags, the score includes a normalized set of numbers representing a strength of connection between the first data of information and the outcome.

14. The system according to claim 12, further comprising:
generating a polarity score which indicates whether the relationship between the event and the outcome is positive or adverse; and
generating a confidence score for the identifying the relationship between the at least one event and the at least one outcome with additional data.

15. The system according to claim 12, wherein the relationship is based on at least one of semantics, causality, and evidence extracted from historical data,
wherein the relationship includes a factual relationship that includes a timestamp indicating when the relationship starts to be valid in time, and a timestamp indicating when the relationship ceases to be valid in time.

16. A computer program product comprising a computer readable storage medium having program instructions embodied therewith, the program instructions readable and executable by a computer to cause the computer to perform a method for identifying and explaining events, comprising:
determining at least one event from a plurality of events;
determining at least one outcome defined by an outcome plan; and
identifying a relationship between the at least one event and the at least one outcome.

17. The computer program product according to claim 16, wherein at least a first data of information being arranged into a temporal space connects the at least one event to the at least one outcome,
wherein the first data of information comprises an information item extracted from data about an individual user, and
wherein the relationship includes a motivation and a score, the motivation comprises an output of an analysis of a link between the first data of information related to the event and the at least one outcome in the outcome plan, the motivation includes fragments of text, or a set of tags, the score includes a normalized set of numbers representing a strength of connection between the first data of information and the outcome.

18. The computer program product according to claim 16, further comprising:
generating a polarity score which indicates whether the relationship between the event and the outcome is positive or adverse; and
generating a confidence score for the identifying the relationship between the at least one event and the at least one outcome with additional data.

19. The computer program product according to claim 16, further comprising:
generating a polarity score which indicates whether the relationship between the event and the outcome is positive or adverse,
wherein the relationship is based on at least one of semantics, causality, and evidence extracted from historical data.

20. The computer program product according to claim 16, wherein the relationship includes a factual relationship that includes a timestamp indicating when the relationship starts to be valid in time, and a timestamp indicating when the relationship ceases to be valid in time.
